(19) United States
(12) Patent Application Publication
(10) Pub. No.: US 2018/0235261 A1
(43) Pub. Date: Aug. 23, 2018

(54) APPARATUS, SYSTEM AND METHOD FOR SEARING, FLATTENING, AND BROWNING FOOD PRODUCTS

(71) Applicant: Unitherim Food Systems, LLC, Bristow, OK (US)

(72) Inventors: Adam Thomas Cowherd, Tulsa, OK (US); David Howard, Bristow, OK (US)

(21) Appl. No.: 15/440,859

(22) Filed: Feb. 23, 2017

(51) Int. Cl. A23L 13/50; A23L 5/10; A23P 30/00

(52) U.S. Cl. CPC A23L 13/50; A23V 2002/00; A23P 30/00; A23L 5/10

(57) ABSTRACT

An apparatus, system and method are provided for flattening and searing a food product wherein a searing and flattening roller is heated to a temperature of at least 600° F. and the heated searing and flattening roller is used to sear an upper surface of the food product and produce a flatter thickness profile of the food product by contacting and applying a pressing force to the upper surface of the food product. Alternatively, the roller can be a flattening and steam ejection roller which flattens the food product and sterilizes the upper surface of the product.

### FIELD OF THE INVENTION

The present invention relates to apparatuses, systems and methods for flattening, searing, and browning poultry, meat, fish, and other food products.

### BACKGROUND OF THE INVENTION

There is currently a desire to provide pre-cooked food products having the same appearance and flavor profiles as products produced by traditional cooking methods. There is also a desire to develop unique new products that cannot be easily duplicated.

To succeed in such endeavors at production volumes of from 200 to 15,000 pounds per hour or more, it is necessary to invest in continuous processes that are also unique, but which identify with or simulate historical batch kitchen techniques. For example, when cooking on a skillet or griddle, it is not uncommon to observe the chef applying pressure to chicken breasts, burgers, and other products by pressing the products with a spatula or press. This increases the degree of the searing imparted to the side of the product which is in contact with the hot cooking surface.

In addition, for continuously cooking chicken breasts and other protein products which are non-uniform in regard to the size and shape of the individual product pieces, a need also exists for a more effective and safer method, apparatus, and system for creating a uniform thickness of the product pieces prior to cooking. If, for example, a chicken breast is 15 mm thick and, along with numerous other chicken breasts, is placed on an oven belt which is 1 meter in width, the necessary cook time for this entire set of product pieces is dictated by the product pieces which have the greatest thickness, even if, for example, 90 percent or more of the product pieces are 13 mm thick or less. Thus, in order to ensure that the few “out-of-specification” thicker pieces are adequately cooked, all of the remaining “in-specification” pieces must be overcooked, resulting in significant yield loss.

Heretofore, the food industry has attempted to use flattening apparatuses to create a more uniform thickness for poultry products and other proteins. These flattening apparatuses have typically operated by continuously squeezing the product pieces between two conveyor belts. However, a common problem with all of these apparatuses is that cross-contamination of the product pieces occurs as the product travels through the flattener. A flattener or poultry press will typically operate at a product rate of from 200 to 15,000 pounds per hour or more. In such volumes, all poultry will harbor pathogens such as Salmonella, E Coli, and Listeria.

By way of example, during an investigation into the cause of a contamination problem at one facility, it was determined, and was personally observed by us, that the problem was being caused by cross-contamination occurring in a poultry flattening system. This was an entirely new facility costing over $100 million which was at risk of losing its largest customer and being closed.

This case and many others are reflective of the fact that, with the growth of demand for pre-cooked ready-to-eat meat products, there exists a continuing need for improved processing apparatuses, systems and methods which will eliminate food safety risks such as those which are currently created in poultry flattening systems and in related systems and equipment. As early as the mid-1990's, the American Meat Institute (A.M.I.) lobbied the U.S.D.A. to introduce protocols for Hazard Analysis Critical Control Points (HACCP) in food processing systems. Since that time, it has been recognized that a great need exists in the industry for identifying and monitoring critical points in food processing systems in order to develop objectives and goals for controlling pathogen or bacterial growth and to stimulate the development of solutions to reduce or eliminate contamination risks and improve food safety.

A need also exists for an apparatus, system and method for producing golden brown highlights and/or solid color on chicken breasts and other products which match the appearance, texture, and taste effects created, for example, by manually pressing the product on the surface of a skillet or griddle as described above.

In one process currently used in the food processing industry for browning, a caramel browning material is applied to the surface of the product prior to cooking. Companies such as Red Arrow and Kerry Ingredients make a variety of coatings to enhance color, often without adding flavor. One such product, MAILLOSE, is a derivative of sugar and is used as a “flavorless” browning agent. However, in addition to the costs of purchasing and applying such browning agents, the browning agents are unable to duplicate such effects as the seared appearance, texture and taste effects as created, for example, by the manual pressing technique discussed above. Nor does the mere application of a browning agent operate in any way to help provide a more uniform product thickness for cooking.

To achieve both flattening and browning effects, some in the industry have used a flattener of the type described above followed by a belt grill. The belt grill typically comprises two Teflon belts that are conveyed over a thermal oil hot plate. The height of the gap between the Teflon belts can be set so that the chicken breasts or other protein products traveling through the belt grill are compressed and are browned on at least one side. The product is then typically conveyed through a char-marker for creating grill marks and then into an oven for cooking.

Unfortunately, a belt grill of this type, heated by thermal oil, will typically be limited to an operating temperature of only 300° F. to 350° F. or less. Thus, the searing effect produce by the belt grill is less pronounced and requires a longer dwell time which affects product yield, texture, and appearance. Moreover, the Teflon belts used in these grills have a life expectancy of only 40 hours and can cost from $8,000 to $12,000 to replace, depending on their length. Furthermore, in addition to the cross-contamination risks, as discussed above, created by the flattener apparatus, the belt grill itself, when searing meat products, leaks uncooked juices and fats that can also cross-contaminate the facility. In addition, further cross-contamination issues are often caused by the char-marker apparatuses used in these systems which can create pools of bacteria that can be spread throughout the factory.

As another option, continuous brander/searer apparatuses, sometimes referred to as “flame grills”, have also been used in the industry for searing and branding the surfaces of some food products prior to cooking. A continuous brander/searer apparatus will typically comprise: (a) a direct flame or infrared searing section which browns, chars, and/or seals the product surface and (b) a rotary brander which contacts the product to leave branded stripes on the product surface which are intended to resemble grill marks.

The searing section of a brander/searer apparatus will typically comprise: (a) an open conveyor belt, (b) a series of upper searing burners (e.g., blue ribbon flame burners or gas infrared burners), each of which extends laterally across the top of the product conveyor belt for discharging heat (preferably flame) downwardly onto the top of the product, and (c) a series of lower searing burners, each of which extends laterally beneath the conveyor for discharging heat (preferably flame) upwardly, through the open conveyor belt, onto the bottom of the product. The searing burners will typically operate at a flame temperature of 1000°-2000° F. or more. When the product is directly exposed to the flame as it passes beneath or over the searing burner, the temperature of the outer surface of the product can reach as much as 165° C. F or more.

The branding section of the prior art brander/searer apparatus typically comprises: (a) a rotating shaft which extends laterally over the open conveyor, (b) a series of side-by-side, spaced apart, radially extending branding rings which are retained on the rotating shaft, (c) a heating element (typically a blue ribbon flame burner) which heats the metal branding rings, and (d) a motor or other system which drives the rotation of the rotating shaft at a speed substantially matching the speed of the open conveyor. As the food product is conveyed beneath the brander, the outer edges of the hot branding rings contact the surface of the product and leave branded stripes on the product surface.

In order to accommodate chicken breasts and other protein products having different thicknesses and/or contoured shapes, the branding rings and/or the rotating shaft of the rotary brander are “free-floating” so that the branding rings will shift upwardly or downwardly as necessary to adapt to and follow the contoured profiles and the differing thicknesses of the product pieces. Thus the rotary brander does not operate to change the differing contours and thicknesses of the product pieces.

An improved cooking system comprising a brander/searer apparatus upstream of a spiral cooking oven is disclosed in U.S. Pat. No. 8,728,555. In the system of U.S. Pat. No. 8,728,555, the appearance of the product is further improved by (a) controlling the gas exhaust rate from the brander/searer apparatus to increase the back pressure and gas product temperature in the brander/searer and (b) adding some or all of the gas exhaust from the brander/searer apparatus to the cooking environment in the spiral oven.

However, although the method used in U.S. Pat. No. 8,728,555 improves the appearance of the branded stripes and the color between the stripes as compared to a home grilled product, the system does not provide a more uniform product thickness for cooking and does not provide the kitchen seared appearance of a product which has been manually pressed on the hot surface of a skillet or griddle.

### SUMMARY OF THE INVENTION

The present invention satisfies the needs and alleviates the problems discussed above. The inventive apparatus, system and method reduce or eliminate the need to apply browning agents or other color enhancers to the surface of the product. Rather, the inventive apparatus, system and process create a natural color, appearance, texture, and flavor by applying heat and pressure. The natural color, appearance, texture, and flavor produced by the inventive system and process match the seared characteristics produced by manually pressing the product against the hot surface of a skillet or griddle. Moreover, in addition to searing, the inventive apparatus, system and method also flatten the raw product to provide a uniform product thickness which is subsequently retained during cooking. In addition, the inventive system and method operate to sterilize the surface of the product.

Examples of products which can be flattened to a desired thickness and seared using the inventive apparatus, system and method include, but are not limited to, boneless chicken breasts, bone-in chicken breasts, flat-iron steak, salmon, scallops, sausage patties, hamburgers, sheet-meat, bacon, veggie based proteins, and schnitzel.

In one aspect there is provided an apparatus for flattening and searing a food product. The apparatus preferably comprises: a housing; a conveyor having a carrying run extending into the housing for continuously carrying the food product; a flattening and searing roller which is rotatably positioned laterally in the housing with respect to the carrying run of the conveyor, the flattening and searing roller having an outer contacting and searing surface; and one or more heating elements which heat the outer contacting and searing surface of the flattening and searing roller to a temperature of at least 600° F.

The height of the flattening and searing roller is adjustable to form a pressing gap beneath the flattening and searing roller of a height wherein, as the carrying run of the conveyor delivers the food product into the pressing gap, the outer contacting and searing surface of the flattening and searing roller contacts and applies a pressing force to the upper surface of the food product so that the flattening and searing roller both (i) sears the upper surface of the food product and (ii) produces a flatter thickness profile of the food product.

The apparatus can also comprise a second lateral roller, positioned vertically below the flatting and searing roller, to resist the pressing force applied to the upper surface of the food product by the flattening and searing roller. If used, the second lateral roller can contact the bottom side of the carrying run of the conveyor. Alternatively, the second lateral roller can directly contact a bottom surface of the food product. The inventive apparatus can also further comprise one of more heating elements which heat the outer contacting surface of the second lateral roller to a temperature of at least 600° F.

In another aspect, there is provided an apparatus for flattening and searing a food product. The apparatus preferably comprises: a housing; a conveyor having a carrying run extending longitudinally into the housing for continuously carrying the food product; a flattening and searing roller which is rotatably positioned laterally in the housing above the carrying run of the conveyor, the flattening and searing roller having an outer contacting and searing surface; and one or more heating elements which heat the outer contacting and searing surface of the flattening and searing roller to a temperature of at least 600° F.

The height of the flattening and searing roller above the top side of the carrying run of the conveyor is adjustable to form a gap of a height wherein, as the conveyor carries the food product through the gap, the outer contacting and searing surface of the flattening and searing roller contacts an upper surface of the food product and presses the food product against the top side of the carrying run of the conveyor so that the flattening and searing roller both (i) sears the upper surface of the food product and (ii) produces a flatter thickness profile of the food product.

In another aspect, there is provided an apparatus for processing a food product which preferably comprises: a housing; a conveyor having a carrying run extending into the housing for continuously carrying the food product; and a flatting and steam ejection roller which is rotatably positioned laterally in the housing above the carrying run of the conveyor, the flattening and steam ejection roller having an outer contacting surface wherein the outer contacting surface has a plurality of steam ejection openings.

The height of the flattening and steam ejection roller above the top side of the carrying run of the conveyor is adjustable to form a gap of a height wherein, as the conveyor carries the food product through the gap, the outer contacting surface of the flattening and steam ejection roller contacts the upper surface of the food product and the flattening and steam ejection roller ejects steam onto the upper surface of the food product so that the flattening and steam ejection roller both (i) sterilizes the upper surface of the food product and (ii) produces a flatter thickness profile of the food product.

The apparatus can also comprise an injection device downstream of the housing, the injection device having injection needles oriented for penetrating the upper surface of the food product to inject brine, a flavoring solution, or other fluid into the food product after the flattening and steam ejection roller has contacted and sterilized the upper surface of the food product.

Similarly, the apparatus could include a mechanical meat tenderizer downstream of the housing. Mechanical meat tenderizers commonly have multiple blades which are inserted into a protein product to break the product membranes.

In another aspect, there is provide an apparatus for processing a food product wherein the apparatus comprises: a housing; a conveyor having a carrying run extending into the housing for continuously carrying the food product; a flattening and sterilizing roller which is rotatably positioned laterally in the housing above the carrying run of the conveyor, the flattening and sterilizing roller having an outer contacting surface; and a plurality of steam ejection openings provided in the contacting surface of the flattening and sterilizing roller which eject steam to heat and sterilize an outer surface of the food product.

The height of the flattening and sterilizing roller above the top side of the carrying run of the conveyor is adjustable to form a gap wherein the height of the gap is such that, as the conveyor carries the food product through the gap, the outer contacting surface of the flattening and sterilizing roller contacts the upper surface of the food product and presses the food product against the top side of the carrying run of the conveyor so that the flattening and sterilizing roller both (i) sterilizes the upper surface of the food product and (ii) produces a flatter thickness profile of the food product.

In another aspect, there is provided a method of flattening and searing a food product. The method preferably comprises the steps of: (a) carrying the food product into a housing on carrying run of a conveyor; (b) heating an outer contacting and searing surface of a flattening and searing roller to a temperature of at least 600° F., the flattening and searing roller being rotatably positioned laterally in the housing with respect to the carrying run of the conveyor; and (c) searing an upper surface of the food product and producing a flatter thickness profile of the food product by continuously delivering the food product through a pressing gap beneath the flattening and searing roller so that the outer contacting and searing surface of the flattening and searing roller contacts and applies a pressing force to the upper surface of the food product.

The inventive method can also optionally utilize a second lateral roller positioned vertically below the flattening and searing roller wherein (i) the second lateral roller is heated to a surface temperature of at least 600° F. and (ii) the second lateral roller directly contacts and sears a bottom surface of the food product in step (c) as the flattening and searing roller contacts and applies a pressing force to the upper surface of the food product.

In another aspect, there is provided a method of flattening and searing a food product comprising the steps of: (a) heating an outer contacting and searing surface of a flattening and searing roller to a temperature of at least 600° F., the flattening and searing roller being rotatably positioned laterally over the carrying run of a conveyor such that a gap is formed between the flattening and searing roller and a top side of the carrying run of the conveyor and (b) searing an upper surface of the food product and producing a flatter thickness profile of the food product by continuously carrying the food product on the carrying run of the conveyor through the gap formed between the flattening and searing roller and the carrying run of the conveyor so that the outer contacting and searing surface of the flattening and searing roller contacts the upper surface of the food product and presses the food product against the top side of the carrying run of the conveyor.

Further aspects, features, and advantages of the present invention will be apparent to those of ordinary skill in the art upon examining the accompanying drawings and upon reading the following Detailed Description of the Preferred Embodiments.

### BRIEF DESCRIPTION OF THE DRAWINGS

FIG. 1 is an elevational side view of an embodiment 2 of the searing and flattening apparatus provided by the present invention.

FIG. 2 is a perspective view of a searing and flattening roller 26 used in the inventive searing and flattening apparatus 2.

FIG. 3 is an elevational side view of the searing and flattening roller 26.

FIG. 4 is a perspective view of a mounting and drive assembly for the searing and fattening roller 26.

FIG. 5 is an example of a conveyor belt drive system for the inventive searing and flattening apparatus 2.

FIG. 6 schematically illustrates a series arrangement of three consecutive searing and flattening rollers 26a, 26b, and 26c which can alternatively be used in the inventive searing and flattening apparatus 2.

FIG. 7 is an elevational side view of an embodiment 66 of an inventive flattening and steam ejection roller assembly used in an alternative embodiment 60 of the inventive apparatus which is used for flattening and sterilizing an upper surface of a food product.

FIG. 8 is an end view of the inventive flattening and steam ejection roller 66 as seen from perspective 8-8 shown in FIG. 7

FIG. 9 schematically illustrates the alternative embodiment 60 of the inventive apparatus for flattening and surface sterilization.

FIG. 10 schematically illustrates an alternative embodiment 100 of the inventive apparatus for searing and flattening.

### DETAILED DESCRIPTION OF THE PREFERRED EMBODIMENTS

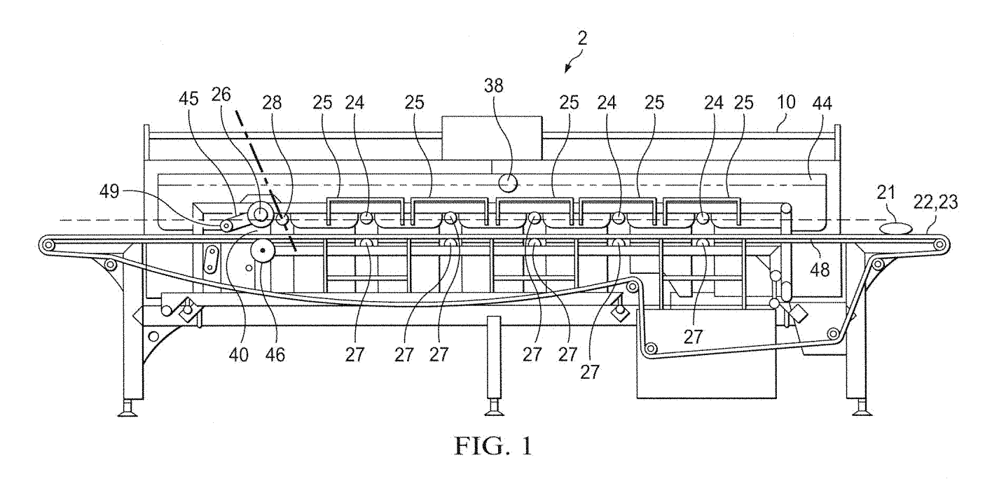

An embodiment 2 of the searing and flattening apparatus provided by the present invention is illustrated in FIG. 1. The searing and flattening apparatus 2 preferably comprises: a housing 10; a conveyor 22 having an upper, longitudinally extending carrying run 23 for continuously conveying the food product 21 through the housing 10; one or more, preferably a plurality of, upper searing burners 24 positioned in the housing 10 above the carrying run 23 of the conveyor 22; one or more, preferably a plurality of, lower searing burners 27 positioned in the housing 10 below the carrying run 23 of the conveyor 22; and at least one rotary searing and flattening roller 26 positioned within the housing 10 above the carrying run 23 of the conveyor 22. The searing and flattening roller 26 is preferably positioned after (i.e., downstream of) the searing burners 24 and 27.

Although other types of burners can also be used, each upper searing burner 24 will preferably be either a blue ribbon flame burner or a gas infrared burner, most preferably a blue ribbon flame burner, which is positioned adjacent to the conveyor 22 and extends laterally above the carrying run 23 of the conveyor 22 for searing the upper surface of the food product. Similarly, each lower searing burner 27 will preferably be either a blue ribbon flame burner or a gas infrared burner, most preferably a blue ribbon flame burner, which is positioned adjacent to the conveyor 22 and extends laterally below the carrying run 23 of the conveyor 22 for either (a) directly searing the bottom surface of the product 21 if an open conveyor 22 is used or (b) heating the carrying run 23 of the conveyor 22 itself if the conveyor 22 is a solid (i.e., non-open) belt. Further, the inventive searing and flattening apparatus 2 can also optionally include interior heat retaining covers 25 (preferably open-bottomed box type covers) over some or all of the upper searing burners 24 positioned above the product conveyor 22.

The one or more upper searing burners 24 used in the inventive searing and flattening apparatus 2 add desirable flame searing and color effects to the top of the incoming raw product and also serve to flame sear and seal the outer perimeter of the product 21 so that no raw edges are visible. It will be understood that some or all of the searing burners 24 could alternatively be positioned in the inventive apparatus 2 after, rather than before, the searing and flattening roller 26.

Similarly, the lower searing burners 27 add desirable searing and color effects to the bottom of the product 21. If a wire mesh, rod-type, or other open-type belt conveyor 22 is used in the inventive apparatus 2, the lower searing burners 27 will operate to directly flame sear the bottom of the product through the open conveyor 22. On the other hand, if a flexible solid (i.e., non-open) metal (preferably stainless steel) conveyor or other solid conveyor 22 is used, the lower searing burners 27 will operate to indirectly sear the bottom of the product, particularly when the product is subsequently pressed by the searing and flattening roller 26, by heating the solid conveyor 22.

It will also be understood, however, that although the inventive apparatus 2 preferably includes upper and lower searing burners 24 and 27 as illustrated in FIG. 1, the inventive searing and flattening apparatus 2 can alternatively (a) have no upper or lower searing burners 24 or 27, (b) have one or more upper searing burners 24 but no lower searing burners 27, or (c) have one or more lower searing burners 27 but no upper searing burners 24.

The searing and flattening roller 26 is rotatably installed in the housing 10 of the inventive searing and flattening apparatus 2 such that the searing and flattening roller 26 extends laterally over the top of the carrying run 23 of the conveyor 22. One or more blue ribbon flame burners or other heating elements 28 is/are preferably installed adjacent to (preferably parallel to and extending along most or the entire length of) the searing and flattening roller 26 for heating the searing and flattening roller 26 to a suitable searing temperature by direct flame impingement onto the roller 26. However, it will be understood that the searing and flattening roller 26 can alternatively be heated to a suitable searing temperature in other ways such as, for example, induction or electrical heating.

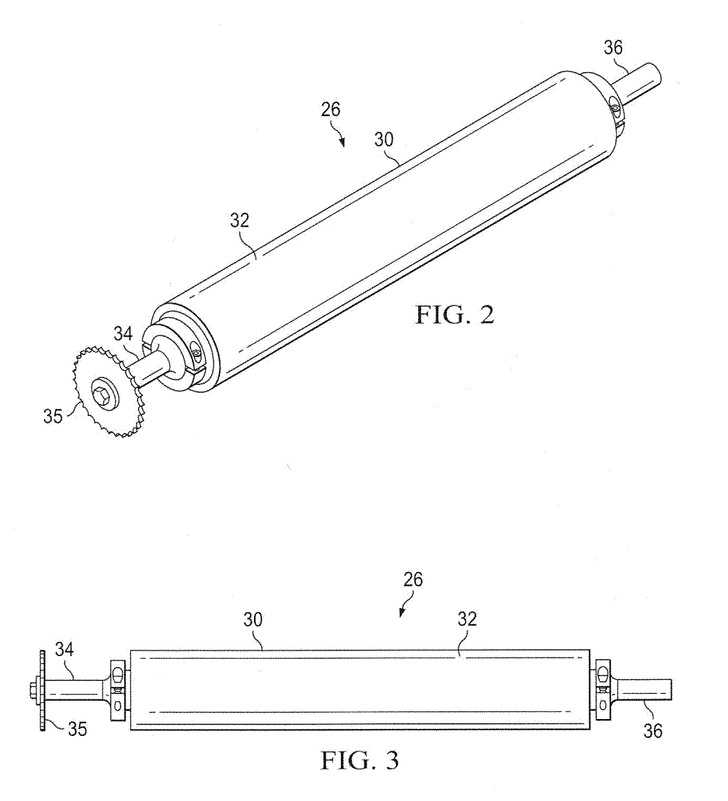

The searing and flattening roller 26 is further illustrated in FIGS. 2-4. The outer contacting and searing surface 32 of the searing and flattening roller 26 will preferably be heated to a temperature of at least 140° F. or at least 150° F. or at least 160° F. or at least 450° F. or at least 500° F. or at least 600° F. or at least 700° F. or at least 750° F. or at least 800° F. or at least 850° F. or at least 900° F. The outer contacting and searing surface 32 of the roller 26 will preferably be heated to a temperature in the range of from 160° F. to 2,000° F. and will more preferably be heated to a temperature in the range of from 600° F. to 1100° F.

The searing and flattening roller 26 preferably comprises a cylindrical roller body 30 having a solid (i.e., non-open) outer cylindrical contacting and searing surface 32 and having shaft ends 34 and 36 of reduced size projecting from the ends of the roller body 30 for rotatably mounting the searing and flattening roller 26 in a roller frame 21. A pulley, sprocket, or gear 35 is provided on the end of shaft 34 for driving the searing and flattening roller 26 using a drive belt or a drive chain or be direct gear to gear drive with a drive motor.

The body 30 of the searing and flattening roller 26 will preferably be formed of a material which can be heated to a glowing cherry red color by the ribbon burner element(s) 28 and will not deteriorate at temperatures of up to 2000° F. and higher. Examples of suitable materials include, but are not limited to, 304, 316, 310, or 347 stainless steel or Inconel. The body 30 of the searing and flattening roller 26 will preferably be formed of 310 or 347 stainless steel or Inconel. By way of example, but not by way of limitation, the cylindrical body 30 of the searing and flattening roller 26 can be formed of a segment of stainless steel or Inconel pipe.

During operation, the outer contacting and searing surface 32 of the searing and flattening roller 26 is preferably rotated at a speed matching or substantially matching (i.e., within −5% to +5% of) the speed of the conveyor 22.

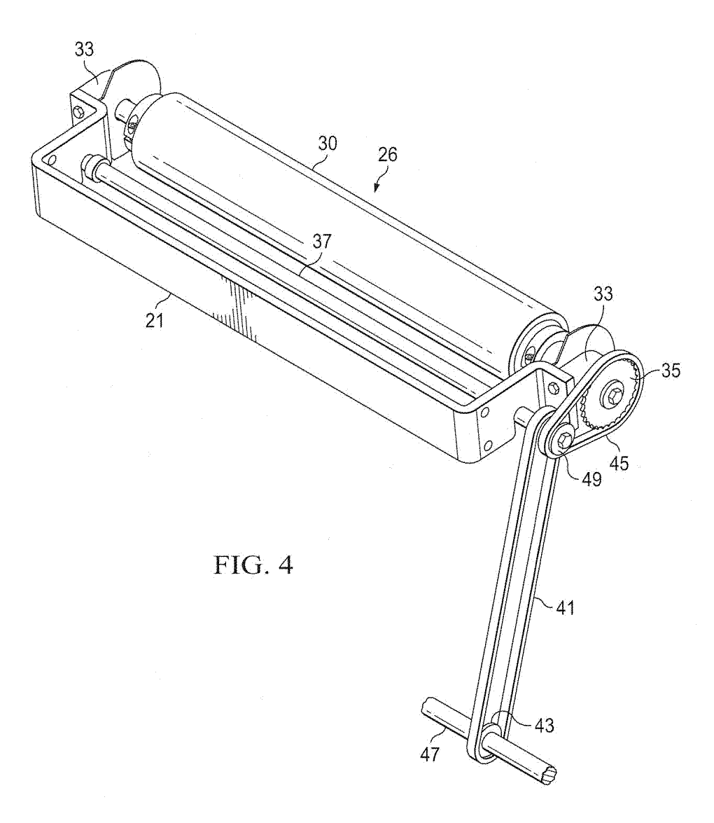

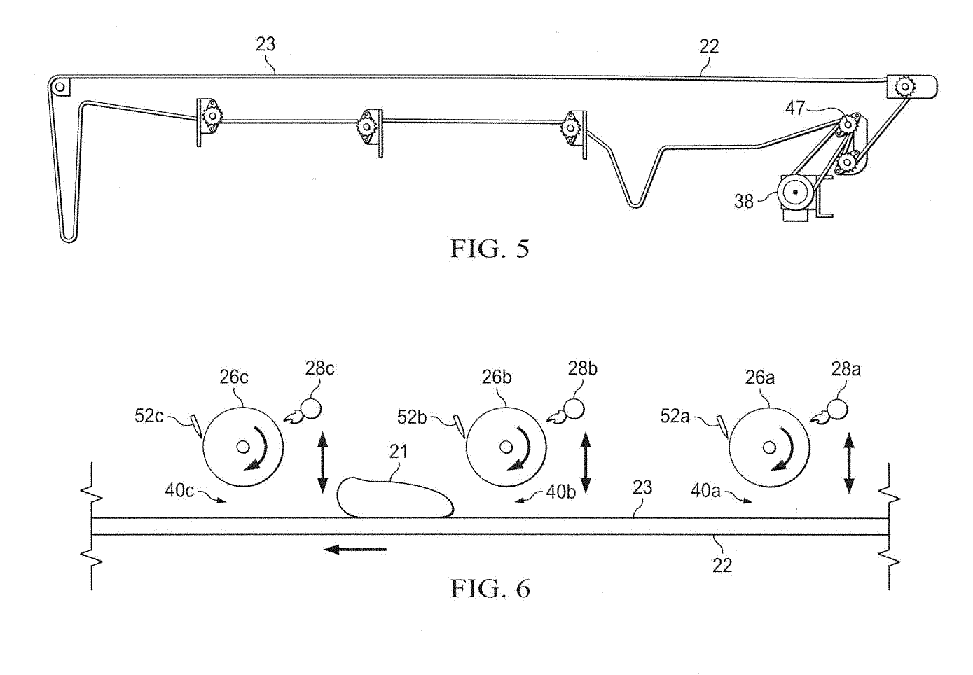

By way of example, a drive assembly for the searing and flattening roller 26 is illustrated in FIGS. 4 and 5. The roller 26 is rotatably mounted in the roller frame 31 using a pair of bearings or low friction bushings 33 through which the roller shaft ends 34, 36 are rotatably received. The roller drive assembly comprises: (a) a drive shaft 37 which is rotatably mounted in the frame 31 adjacent to the roller 26; (b) a drive belt 39 which extends to a sprocket 41 on the drive shaft 37 from a sprocket 43 secured on either the drive shaft of the drive motor 38 for the apparatus conveyor 22 or other drive shaft 47 of the conveyor 22; and (c) a drive belt 45 which extends from a second sprocket 49 on the roller assembly drive shaft 37 to the sprocket 35 on the roller shaft 34.

An example of a conveyor belt drive system which can be used in the inventive apparatus 2 is illustrated in FIG. 5.

The frame 31 of the searing and flattening roller 26 is adjustably mounted in the housing 10 of the inventive apparatus 2 for raising and lowering the roller 26 in order to selectively increase, decrease and set the height of the gap 40 provided between the outer contacting and searing surface 32 of the body 30 of the roller 26 and the top of the carrying run 23 of the conveyor 22. The gap 40 will be set at a height which is less than a thickness of the incoming food product 21 to flatten the product 21 to the uniform product thickness desired for the cooking and to allow the searing and flattening roller 26 to apply a firm pressing force to the upper surface of the product 21 while the roller 26 sears the product surface.

The frame structure 31 for the searing and flattening roller 26 can be mounted in the apparatus housing 10 in any manner effective to allow the height of the gap 40 between the roller 26 and the carrying run 23 of the conveyor 22 to be adjusted. The roller frame structure 31 will preferably be adjustably installed in the housing 10 by attaching or linking the frame 31 to a screw jack assembly installed in the housing 10.

To assist in flattening the product to a uniform height, a second (i.e., lower) roller 46 can also be rotatably installed in the housing 10 against the underside 48 of the conveyor 22 in vertical alignment with the searing and flattening roller 26. During the flattening process, the lower roller 46 supports the carrying run 23 of the conveyor 22 against the compressive flattening force which is applied to the product 21 by the searing and flattening roller 26 so that the set height of the gap 40 is maintained and a uniform, consistent thickness for all of the flattened product pieces is achieved. In other words, the lower roller 46 resists the pressing force applied to the upper surface of the food product 21 by the upper flattening and searing roller 26 as the food product 21 is delivered through the gap 40 beneath the upper flattening and searing roller 26. The lower roller 46 can also optionally be heated, either in the same manner as or in a different manner than the upper searing and flattening roller 26.

Although the use of a lower roller 46 to resist the pressing force applied to the food product 21 by the upper flattening and searing roller 26 and thereby prevent the conveyor belt 22 from being deflected downward is preferred, it will also be understood that a solid supporting plate or other structure could instead be installed beneath and against the underside 48 of the carrying run 23 of the conveyor 22 to support the conveyor 22 against the compressive flattening force applied to the product by the searing and flattening roller 26, and thus maintain a constant gap height.

As another alternatively, the inventive searing and flattening apparatus can instead be operated without using a lower belt support roller 46 or other conveyor support structure beneath the searing and flattening roller 26. As illustrated in FIG. 6, the absence of a lower roller 46 or other support structure beneath the carrying run 23 of the conveyor 22 permits the conveyor 22 to flex downwardly to some degree, depending upon the tightness of the conveyor belt 22, as the product pieces 21 are pressed against the conveyor 22 by the searing and flattening roller 26. This slight downward flexing of the conveyor 22 can be beneficial in some cases in that, for example, bone-in products can be flattened without breaking the bones and softer products can be flattened on a wire mesh or other open belt-type conveyor 22 without being cut or damaged to any significant degree by the belt 22.

The inventive searing and flattening apparatus 2 can also alternatively use more than one adjustable searing and flattening roller 26 above the conveyor 22. FIG. 6 illustrates the use of a series of three searing and flattening rollers 26a, 26b, and 26c in the inventive apparatus above the carrying run 23 of the conveyor 22. Each of the rollers 26a, 26b, and 26c has at least one blue ribbon flame burner 28a, 28b, or 28c or other heating element or system associated therewith for heating each of the rollers 26a, 26b, and 26c to a desired searing temperature, preferably to a preferred roller temperature as discussed above. FIG. 6 further illustrates the installation of elongate scraping blades 52a, 52b, and 52c in the apparatus housing 2 in contact with the milers 26a, 26b, and 26c to prevent residue build-up.

The flattening gaps 40a, 40b, and 40c between the rollers 26a, 26b, and 26c and the carrying run 23 of the conveyor 22 can be at the same height or at any desired combination of different heights. As one example, a progressive flattening arrangement can be used wherein the gap height of the rollers 26a, 26b, and 26c progressively decreases so that (a) the height of the first flattening gap 40a is less than a thickness of the product 21, (b) the height of the second flattening gap 40b is less than the first flattening gap 40a, and (c) the height of the final flattening gap 40c is less than the height of the second flattening gap 40b.

In addition to assisting in the flattening process, the use of multiple searing and flattening rollers 26a, 26b, 26c in series also operates to increase the capacity and production rate of the searing and flattening apparatus 2.

Although the body 30 of the searing and branding roller 26 has thus far been described as having a cylindrical shape, other shapes can also be used. If, for example, a square cross-sectional shape is used, the square roller will operate to press and/or sear the product at the points at which the heated square roller contacts the product. As another example, if a ribbed, beveled, or multi-point roller is used, the roller will tenderize and/or flatten, and/or shape the product. Whole muscle protein would benefit from breakage of the membrane which can contract during the cooking process, causing the product to curl.

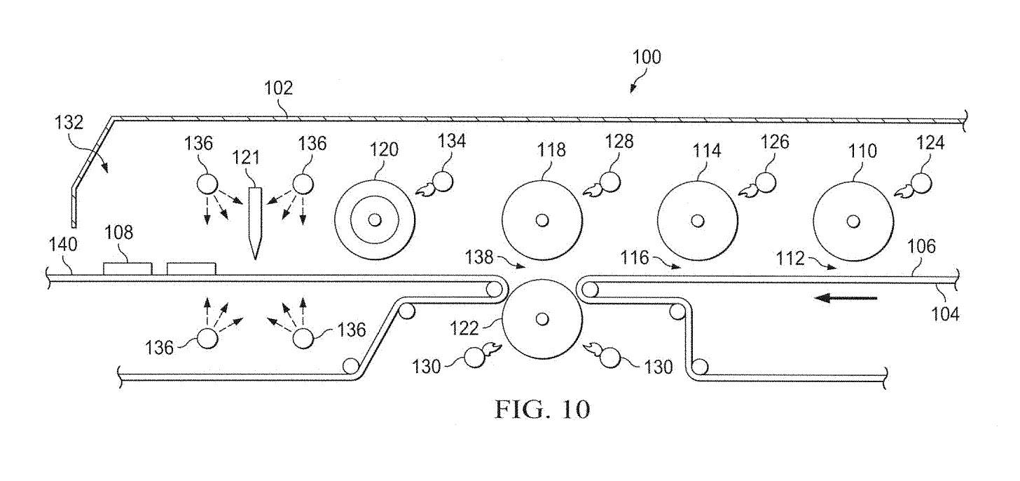

In addition, although the searing and flattening roller 26 has been shown thus far as having a smooth contacting and searing surface 32, it will be understood that other desired effects can be produced on the scared product by adding texture, dimples, wavy patterns, indented designs, or other features to the roller contacting and searing surface 32. Moreover, one or more subsequent branding rollers (e.g., the branding roller 120 included in the alternative embodiment of FIG. 10 discussed below) having diamond-shaped patterns or other branding patterns thereon can be added after the searing and flattening roller 26 in order to brand such designs onto the seared and flattened surface produced by the roller 26. By installing such branding roller(s) within the hot interior of the housing 10 of the sealing and flattening apparatus 2, the temperature of the contacting surfaces of the branding roller(s) will be maintained well above the lethality point for pathogens.

When using the inventive searing and flattening apparatus 2 for continuously searing and flattening sheet meat and continuously delivering the seared and flattened sheet product into a spiral oven for cooking, a flying guillotine or other cutter (e.g., the flying guillotine cutter 121 included in the alternative embodiment of FIG. 10, discussed below) for cutting the continuous sheet into sections of desired length can be installed internally in the exit section 49 of the inventive searing and flattening apparatus 2 after the searing and flattening roller(s) 26. The cutter blade would cut the bonded chicken breast or sheet meat into slabs which can travel around the collapsing winding belt of the spiral oven.

Heretofore, the cutting blades used with prior flatteners, as well as the seared sheet product being cut, have been exposed to the atmosphere. Consequently, the cutting blade has presented a further point of product cross-contamination. However, in the inventive system, by installing the cutting blade internally in the exit section 49 of the inventive searing and flattening apparatus, the cutting blade is shielded from the atmosphere and is continuously maintained above the lethality temperature for pathogens.

During the operation of inventive searing and flatting system 2 in accordance with the inventive method for searing and flattening chicken breasts or other food product pieces 21, the product pieces 21 are continuously conveyed through the searing and flattening apparatus 2 wherein (a) one or both of the upper and lower surfaces of each product is/are seared to resemble a product which has been manually pressed against the hot surface of a skillet or griddle and (b) the product pieces are flattened to provide a flatter, more uniform thickness profile. The seared and flattened product pieces are then preferably continuously delivered through a spiral, linear or other oven wherein they are cooked (preferably fully cooked). The resulting “precooked” products can then be packaged, sealed and chilled.

The result of this process is a packaged precooked product which meets the requirements of Alternative 2 under U.S.D.A. regulations. Therefore, the inventive method, in addition to increasing the yield and improving the appearance, texture and flavor of the product, also extends the shelf life of the product. Also, significant additional savings are realized by eliminating or reducing the need to inject the product with anti-microbials such as sodium lactate, which have heretofore been required in order to provide an acceptable shelf life.

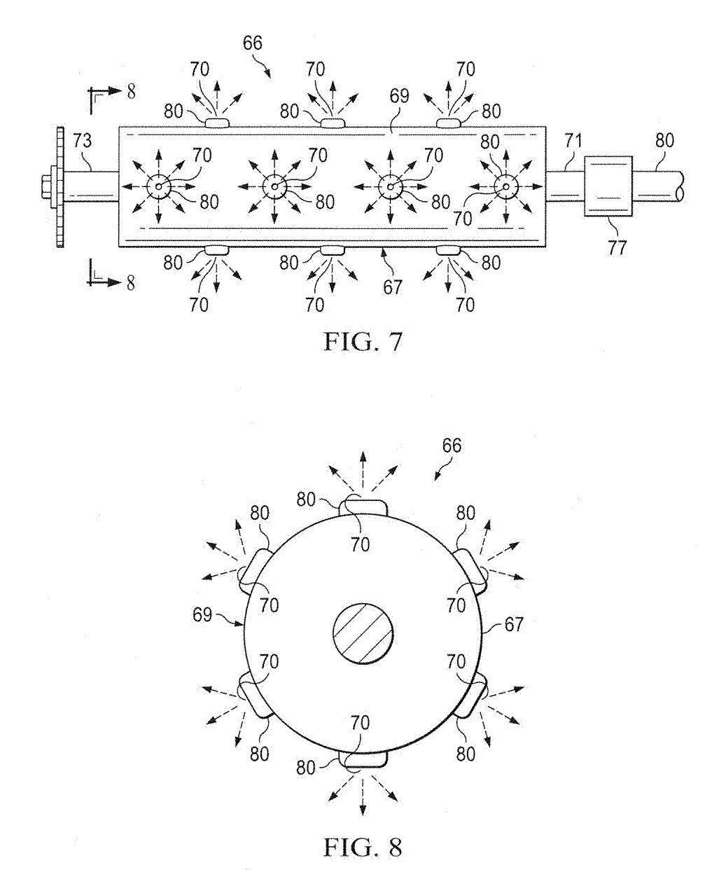

An alternative embodiment 60 of the inventive apparatus is illustrated in FIGS. 7-9. The inventive apparatus 60 is a steam heated flattener for chicken breasts or other poultry, or for other meat and fish products, as well as bonded chicken and other sheet meat products. The apparatus 60 comprises: a housing 62; a conveyor 64 for continuously delivering the product 72 through the housing 62; and at least one flattening and steam ejection roller 66 which is positioned over the carrying run 65 of the conveyor 64. The height of the flattening and steam ejecting roller 66 can be adjusted up and down for changing and setting the height of the pressing gap(s) 68 between the roller(s) 66 and the conveyor 64.

The flattening and steam ejection roller 66 can be adjustably installed in the housing 62 of the apparatus 60 in the same manner as the searing and flattening roller 26 described above. As schematically illustrated in FIGS. 7 and 8, the flattening and steam ejection roller 66 preferably comprises: a roller body 67 having a hollow interior and an outer contacting/pressing surface 69; axle end segments 71 and 73 which project from the roller body 67 for rotatably mounting the roller 66 in a roller frame: a plurality of stem ejection openings 70 in the contacting surface 69 of the roller 66; and a rotary union 77 linking the end axle segment 71 to a steam supply hose or other conduit 80. The axle segment 71 has a flow passage extending therethrough so that steam from the supply conduit 80 flows into the hollow interior of the roller 66 and is then ejected from the steam ejection openings 70.

The steam ejection openings 70 eject wet steam or superheated steam, preferably superheated (dry) steam, from the flattening and steam ejecting roller 66 in an amount and in a manner to heat the surface 74 of the food product 72 to a temperature of at least 140° F., more preferably at least 150° F., at least 155° F., at least 160° F., at least 165° F., at least 170° F., at least 175° F., or at least 180° F., or preferably a temperature in the range of from 180° to 212° F. The flattening and steam ejecting roller 66 preferably impinges the ejected steam directly onto the surface 44 of the product 72.

The continuous steam ejection from the flattening and steam ejection roller 66 both (a) sterilizes the roller 66 and (b) also kills any pathogens present on the pressed surface 74 of the food product 72, thus preventing cross-contamination. The pressed product surface 74 produced by flattening and steam ejection roller 66 is also non-stick, so that the product surface 44 easily separates from the roller 66, and is sufficiently rigid that it will not adopt any imprinted pattern, for example, from the oven belt when the flattened product 72 is later cooked.

To prevent steam ejection openings 70 from cutting into the food product 72, the body 67 of the roller 66 can also optionally be adapted so that the steam ejection openings 70 are recessed in slightly raised, inverted dimples 80 formed on the surface 69 of the roller body 67.

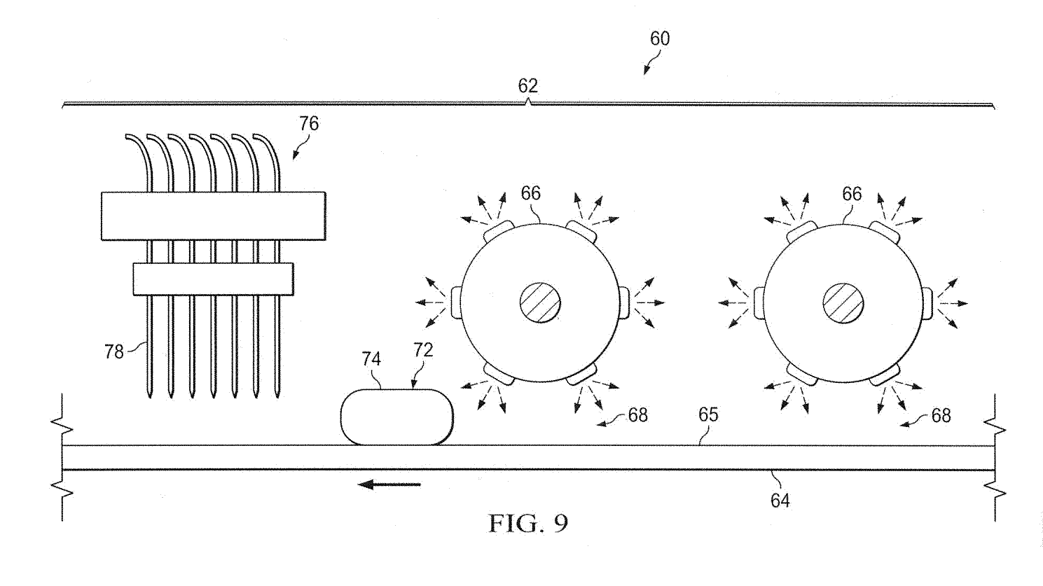

FIG. 9 further illustrates a needle injection device 76, positioned downstream of a series of two flattening and steam ejecting rollers 66. The needle injection device 76 is for injecting brine, flavorings, or other solutions into the flattened product 72. Because the pressed upper surface 74 produced by the inventive flattening and sterilizing apparatus 60 is pathogen free, the insertion of the injection needles 78 of the injection device 76 through the pressed surface 74 will not push any pathogens from the pressed surface 74 into the body of the flattened product 72.

Alternatively, instead of or in addition to the needle injection device 76, a mechanical meat tenderizer having multiple blades, or other treatment device having elements which penetrate the sterilized surface 74 of the product 72, can be positioned downstream of one or more flattening and steam ejection rollers 66.

The use of the inventive steam-heated flattening apparatus 60 immediately ahead of the injection device 76 therefore eliminates an important cross-contamination problem which has been prevalent in the industry. Recalls of protein products have occurred at multiple facilities wherein, when injecting protein products in their raw state with brine, flavoring solutions, or other fluids, pathogens present on the injected surface of one or more pieces of the product have been picked-up by the injection needles. The infected injection needles then carry the pathogens into the interiors of the product pieces in question and also cross-contaminate other product pieces which are subsequently injected.

The inventive steam-heated flattening apparatus 60 can also optionally include one or more lower rollers rotatably installed in the housing 62 against the underside of the carrying run 65 of the conveyor 64 and in vertical alignment with the upper flattening and steam ejection roller(s) 66 for supporting the conveyor 64 against the compressive flattening force applied to the product 72 by the flattening roller(s) 66.

Another embodiment 100 of the inventive searing and flattening apparatus is illustrated in FIG. 10. The inventive apparatus 100 comprises: a housing 102; a conveyor 104 having an upper carrying run 106 for continuously carrying a food product 108 into the housing 102; a first lateral searing and flattening roller 110 which is adjustably mounted in the housing 102 above the carrying run 106 of the conveyor 104 for adjusting the height of a pressing gap 112 between the first upper roller 110 and the carrying run 106 of the conveyor 104; a second lateral searing and flattening roller 114, following the first roller 110, which is adjustably mounted in the housing 102 above the carrying run 106 of the conveyor 104 for adjusting the height of a pressing gap 116 between the second upper roller 114 and the carrying run 106 of the conveyor 104; a third upper lateral searing and flattening roller 118 adjustably mounted in the housing 102 following the second upper roller 114; and a lower lateral searing roller 122 which is mounted vertically below the third upper searing and flattening roller 118. The upper searing and flattening rollers 110, 114, and 118 are driven in a direction of rotation which is opposite the direction of rotation of the conveyor 104. The lower searing roller 122 is driven in a direction of rotation which is the same as the direction of rotation of the conveyor 104.

The inventive searing and flattening apparatus 100 further comprises: one or more blue ribbon flame burners or other heating elements 124 adjacent to the first upper flattening and searing roller 110 for preferably heating the first upper roller 110 to a searing temperature of at least 600° F. as discussed above; one or more blue ribbon flame burners or other heating elements 126 adjacent to the second upper flattening and searing roller 114 for preferably heating the second upper roller 114 to a searing temperature of at least 600° F. as discussed above; one or more blue ribbon flame burners or other heating elements 128 adjacent to the third upper flattening and searing roller 118 for preferably heating the third upper roller 118 to a searing temperature of at least 600° F. as discussed above; and one, two, or more blue ribbon flame burners or other heating elements 130 adjacent to the lower searing roller 122 for preferably heating the lower roller 110 to a searing temperature of at least 600° F. as discussed above.

The inventive searing and flattening apparatus 100 can also include one or more upper searing burners and/or one or more lower searing burners of the same type as burners 24 and 27 which are used in the inventive apparatus 2 discussed above and illustrated in FIG. 1. The upper and/or lower searing burner(s) will preferably be located in the housing 102 before the first upper searing and flattening roller 110; however, some or all of such upper and/or lower searing burner(s) which may be used in the inventive apparatus 100 can alternatively be located in the housing 102 after the third upper searing and flattening roller 118.

In addition, as mentioned above, the inventive searing and flattening apparatus 100 can optionally include: (a) a heated branding roller 120 mounted inside the outlet end portion 132 of the housing 102 following the searing and flattening rollers 110, 114, and 118 for branding a design on the seared upper surface of the food product 108 and/or (b) a flying guillotine or other cutter 121 mounted inside the outlet end portion 132 of the housing 102 for cutting bonded chicken or other sheet meat products if processed in the inventive apparatus 100. The branding roller 120 will preferably be heated by one or more blue ribbon flame burners or other heating elements 134 adjacent to the branding roller 120. One or a plurality of steam ejection headers or nozzle assemblies 136 can also be installed in the housing for sterilizing the cutter 121 and helping to ensure that a sufficient temperature for pathogen lethality is maintained in the outlet end portion 132 of the housing 102.

The inventive apparatus 100 differs from the embodiments of the inventive searing and flattening apparatus illustrated in FIGS. 1 and 6 in that, in the apparatus 100, the upper searing and flattening roller 118 does not press the food product 108 against the carrying upper carrying run 106 of the conveyor 104 but instead presses the food product 108 directly against the lower searing roller 122. Consequently, as the food product is being flattened in an adjustable pressing gap 138 formed between the upper searing and flattening roller 118 and the lower searing roller 122, the heated upper roller 118 directly contacts and sears the upper (top) surface of the food product 108 and the heated lower roller 122 directly contacts and sears the bottom surface of the food product 108. The food product is continuously delivered into the pressing gap 138 between the upper searing and flattening roller 118 and the lower searing roller 122 by the conveyor 104. The counter rotation of the upper and lower rollers 118 and 122 then pulls the food product 108 through the pressing gap 138 and deposits the flattened and seared product onto an exit conveyor 140. The exit conveyor 140 extends below the optional heated branding roller 120 and the optional cutter 121 and carries the food product 108 out of the housing 102.

Although the inventive searing and flattening apparatus illustrated in FIG. 10 includes two upper searing and flattening rollers 110 and 114 prior to the upper and lower rollers 118 and 122, it will be understood that the prior rollers 110 and 114 could be omitted or that any number of additional searing and flattening rollers could be included before or after the upper and lower rollers 118 and 122. Also, it will be understood that the technique of directly pressing and searing the food product between an upper searing and flattening roller 118 and a lower searing roller 122, as well as the other pressing and searing techniques disclosed herein, can be used either before or after the product is cooked.

Thus, the present invention is well adapted to carry out the objectives and attain the ends and advantages mentioned above as well as those inherent therein. While presently preferred embodiments and steps have been described for purposes of this disclosure, the invention is not limited in its application to the details of the preferred embodiments and steps. Numerous changes and modifications will be apparent to those of ordinary skill in the art. Such changes and modifications are encompassed within this invention as defined by the claims. In addition, unless expressly stated, the phraseology and terminology employed herein are for purposes of description and not limitation.

What is claimed is:

1. An apparatus for flattening and searing a food product comprising:
a housing;
a conveyor having a carrying run extending into the housing for continuously carrying the food product;
a flattening and scaring roller which is rotatably positioned laterally in the housing with respect to the carrying run of the conveyor, the flattening and searing roller having an outer contacting and searing surface; and
one or more heating elements which heat the outer contacting and searing surface of the flattening and searing roller to a temperature of at least 600° F.,
a height of the flattening and searing roller being adjustable to form a pressing gap beneath the flattening and searing roller of a height wherein, as the carrying run of the conveyor delivers the food product into the pressing gap, the outer contacting and searing surface of the flattening and searing roller contacts and applies a pressing force to an upper surface of the food product so that the flattening and searing roller both (i) sears the upper surface of the food product and (ii) produces a flatter thickness profile of the food product.

2. The apparatus of claim 1 further comprising a drive motor directly or indirectly linked to the flattening and searing roller to drive the flattening and searing roller in a direction of rotation.

3. The apparatus of claim 1 wherein the one or more heating elements comprises a blue ribbon flame burner positioned adjacent to the flattening and searing roller.

4. The apparatus of claim 3 wherein the blue ribbon flame burner is positioned to impinge a flame from the blue ribbon flame burner on the outer contacting and searing surface of the flattening and searing roller.

5. The apparatus of claim 1 further comprising a second lateral roller, positioned vertically below the flattening and searing roller, such that the food product travels between the flattening and searing roller and the second lateral roller.

6. The apparatus of claim 5 wherein the second lateral roller contacts a bottom side of the carrying run of the conveyor.

7. The apparatus of claim 5 wherein the second lateral roller directly contacts a bottom surface of the food product and the apparatus further comprises one or more heating elements which heat on outer contacting surface of the second lateral roller to a temperature of at least 600° F.

8. The apparatus of claim 1 wherein the conveyor is a solid metal conveyor belt.

9. The apparatus of claim 1 further comprising one or more searing burners positioned in the housing ahead of the flattening and searing roller, the one or more searing burners being positioned above the carrying run of the conveyor.

10. The apparatus of claim 9 wherein each of the one or more searing burners is a blue ribbon flame burner.

11. The apparatus of claim 1 further comprising one or more searing burners positioned in the housing ahead of the flattening and searing roller, the one or more searing burners being positioned below the carrying run of the conveyor.

12. The apparatus of claim 11 wherein the conveyor is a wire mesh, a rod-type, or other open conveyor belt.

13. The apparatus of claim 1 wherein the flattening and searing roller is a first flattening and searing roller and the apparatus further comprises:
a second flattening and searing roller which is rotatably positioned laterally in the housing with respect to the carrying run of the conveyor and after the first flattening and searing roller, the second flattening and searing roller having an outer contacting and searing surface which contacts and applies a pressing force to the upper surface of the food product; and
one or more heating elements which heat the outer contacting and searing surface of the second flattening and searing roller to a temperature of at least 600° F.

14. The apparatus of claim 13 further comprising:
a third flattening and searing roller which is rotatably positioned laterally in the housing with respect to the carrying run of the conveyor and after the second flattening and searing roller, the third flattening and searing roller having an outer contacting and searing surface which contacts and applies a pressing force to the upper surface of the food product; and
one or more heating elements which heat the outer contacting and searing surface of the third flattening and searing roller to a temperature of at least 600° F.

15. The apparatus of claim 1 further comprising a product sheet cutting blade installed in the housing after the flattening and searing roller.

16. An apparatus for processing a food product comprising:
a housing;
a conveyor having a carrying run extending into the housing for continuously carrying the food product; and
a flattening and steam ejection roller which is rotatably positioned laterally in the housing above the carrying run of the conveyor, the flattening and steam ejection roller having an outer contacting surface wherein the outer contacting surface has a plurality of steam ejection openings,
a height of the flattening and steam ejection roller above a top side of the carrying run of the conveyor being adjustable to form a gap of a height wherein, as the conveyor carries the food product through the gap, the outer contacting surface of the flattening and steam ejection roller contacts an upper surface of the food product and the flattening and steam ejection roller ejects steam onto the upper surface of the food product so that the flattening and steam ejection roller both (i) sterilizes the upper surface of the food product and (ii) produces a flatter thickness profile of the food product.

17. The apparatus of claim 16 further comprising a lateral supporting roller, positioned vertically below the flattening and steam ejection roller, which contacts and supports a bottom side of the carrying run of the conveyor.

18. The apparatus of claim 16 further comprising an injection device downstream of the housing, the injection device having injection needles oriented for penetrating the upper surface of the food product to inject brine, a flavoring solution, or other fluid into the food product after the flattening and steam ejection roller has contacted and sterilized the upper surface of the food product.

19. The apparatus of claim 16 further comprising a mechanical meat tenderizer downstream of the housing.

20. A method of flattening and searing a food product comprising the steps of:
a) Carrying the food product into a housing on a carrying run of a conveyor;
b) heating an outer contacting and searing surface of a flattening and searing roller to a temperature of at least 600° F., the flattening and searing roller being rotatably positioned laterally in the housing with respect to the carrying run of the conveyor; and
c) searing an upper surface of the food product and producing a flatter thickness profile of the food product by continuously delivering the food product through a pressing gap beneath the flattening and searing roller so that the outer contacting and searing surface of the flattening and searing roller contacts and applies a pressing force to the upper surface of the food product.

21. The method of claim 20 wherein the outer contacting and searing surface of the flattening and searing roller is heated in step (a) using at least one blue ribbon flame burner.

22. The method of claim 20 wherein the conveyor is a solid metal conveyor belt.

23. The method of claim 20 wherein a second lateral roller, positioned vertically below the flattening and searing roller, contacts a bottom side of the carrying run of the conveyor in step (c) as the flattening and searing roller contacts and applies the pressing force to the upper surface of the food product.

24. The method of claim 20 wherein a second lateral roller, positioned vertically below the flattening and searing roller, is heated to a surface temperature of at least 600° F. and the second lateral roller directly contacts and sears a bottom surface of the food product in step (c) as the flattening and searing roller contacts and applies to the pressing force to the upper surface of the food product.

25. The method of claim 20 further comprising the step, prior to step (c), of searing the upper surface and an outer edge portion of the food product using one or more searing burners.

26. The method of claim 25 wherein each of the searing burners is a blue ribbon flame burner.

27. The method of claim 20 wherein the conveyor is a wire mesh, a rod-type, or other type of open conveyor belt.

28. The method of claim 27 further comprising the step of searing a bottom surface of the food product using one or more searing burners positioned below the carrying run of the conveyor.

29. The method of claim 20 further comprising the steps of: (i) heating an outer contacting and searing surface of a second flattening and scaring roller to a temperature of at least 600° F., the second flattening and searing roller being rotatably positioned laterally with respect to the carrying run of the conveyor and (ii) prior to step (c), searing the upper surface of the food product and flattening the thickness profile of the food product by continuously delivering the food product through a pressing gap beneath the second flattening and searing roller so that the outer contacting and searing surface of the second flattening and searing roller contacts and applies a pressing force to the upper surface of the food product.

30. The method of claim 20 wherein the food product comprises chicken breasts.

31. The method of claim 20 wherein:
the food product comprises bonded chicken breasts or sheet meat;
a sheet cutting blade is installed in the housing after the flattening and searing roller and the sheet cutting blade is heated in the housing to a sterilizing temperature; and
the method further comprises the step, after step (c), of cutting the food product in the housing using the sheet cutting blade.
